(19) United States
(12) Patent Application Publication
(10) Pub. No.: US 2010/0096449 A1
(43) Pub. Date: Apr. 22, 2010

(54) CAUSE GIFT CARD PLATFORM FOR PROVIDING REDEMPTION OF FUNDS ACROSS MULTIPLE UNAFFILIATED ENTITIES

(75) Inventors: Karl Denzer, Denver, CO (US); Tim Dailey, Littleton, CO (US)

Correspondence Address: SHERIDAN ROSS PC, 1560 BROADWAY, SUITE 1200, DENVER, CO, 80202, US

(73) Assignee: PAYCODE SYSTEMS, INC., Denver, CO (US)

(21) Appl. No.: 12/575,362

(22) Filed: Oct. 7, 2009

Related U.S. Application Data
(60) Provisional application No. 61/107,434, filed on Oct. 22, 2008.
(60) Provisional application No. 61/151,428, filed on Feb. 10, 2009.

(51) Int. Cl. G06K 5/00

(52) U.S. Cl. 235/380

(57) ABSTRACT

A cause gift card system allows for redemption of a gift card with one or more unaffiliated organizations—including both for-profit and not for-profit entities. The system automatically distributes any unredeemed funds to participating entities associated with the particular cause gift card type per defined business rules. The system provides for purchase of cause gift cards through retail merchants, websites, or other authorized sellers for either fixed denominations or variable amounts. The recipient can elect to direct the funds, in whole or in part, to one of a basket of pre-determined organizations that are specific to each cause gift card type, for example, environmental services, health and wellness, political actions, and more.

### CROSS REFERENCE TO RELATED APPLICATIONS

This application claims the benefit of priority pursuant to 35 U.S.C. §119(e) of U.S. provisional application No. 61/107,434 filed 22 Oct. 2008 entitled “Gift card redemption across multiple unaffiliated entities” and 61/151,428 filed 10 Feb. 2009 entitled “Cause gift card platform providing redemption of funds across multiple unaffiliated entities”, each of which is hereby incorporated herein by reference in their entirety.

### BACKGROUND

Currently, gift cards are typically associated with fixed dollar values that can be redeemed at one specific company, for a specific fixed amount, such as a $20 gift card for an electronics store. These gift cards are sold in multiple merchant locations, including within stores, such electronics stores, convenience stores, grocery stores, etc. as well as through other channels, such as websites.

Based on recent industry estimates, approximately $8 billion of the $80 billion that is spent on gift cards is not redeemed, or claimed, by recipients of gift cards. To put this amount in perspective, this value exceeds the combined total of both debit and credit card fraud in the United States. Furthermore, current gifts cards are limited for redemption to a single entity or company, and many contain fees for inactivity or non-use.

Currently there are limited means to give someone the gift of a donation. There are gift cards for a specific charity, such as a United Way card, and gift cards that enable the recipients to choose from a list of multiple, unrelated participating charities, but there are no gift cards that are offered around a specific cause, such as environmental protection or disease research.

### SUMMARY

The disclosed technology relates to offering gift card products to consumers. More particularly, the invention relates to the card design, computer applications and computer systems required for a cause-based gift card that enables redemption across multiple un-affiliated companies that could be both for-profit and not for-profit entities. Implementations described and claimed herein resolve issues surrounding breakage by providing a system and process for automatic redemption of gift card value that is determined by computer systems and business rules. Additionally, the implementation provides a computer system and process that enables value that is stored on a gift card to be redeemed at multiple unaffiliated companies that are pre-defined as part of the redemption options.

### BRIEF DESCRIPTIONS OF THE DRAWINGS

FIG. 1 illustrates a design layout for an exemplary cause gift card

FIG. 2 illustrates an example cause gift card environment for processing merchant connectivity to a processing system.

FIG. 3 illustrates an example architecture for activation of a cause gift card in a cause gift card environment.

FIG. 4 illustrates an example architecture for redemption of a cause gift card in a cause gift card environment.

FIG. 5 illustrates example operations for redeeming a cause gift card in a cause gift card environment.

FIG. 6 illustrates an example screen shot for redeeming a cause gift card in a cause gift card environment.

FIG. 7 illustrates example operations for a system administrator to establish business rules for managing the basket of redemption options by merchant or seller of the cause gift card.

FIG. 8 illustrates a tax reporting subsystem for reporting to the purchaser the total value of funds redeemed at tax exempt entities.

FIG. 9 illustrates an example system for implementing the described technology.

### DETAILED DESCRIPTION

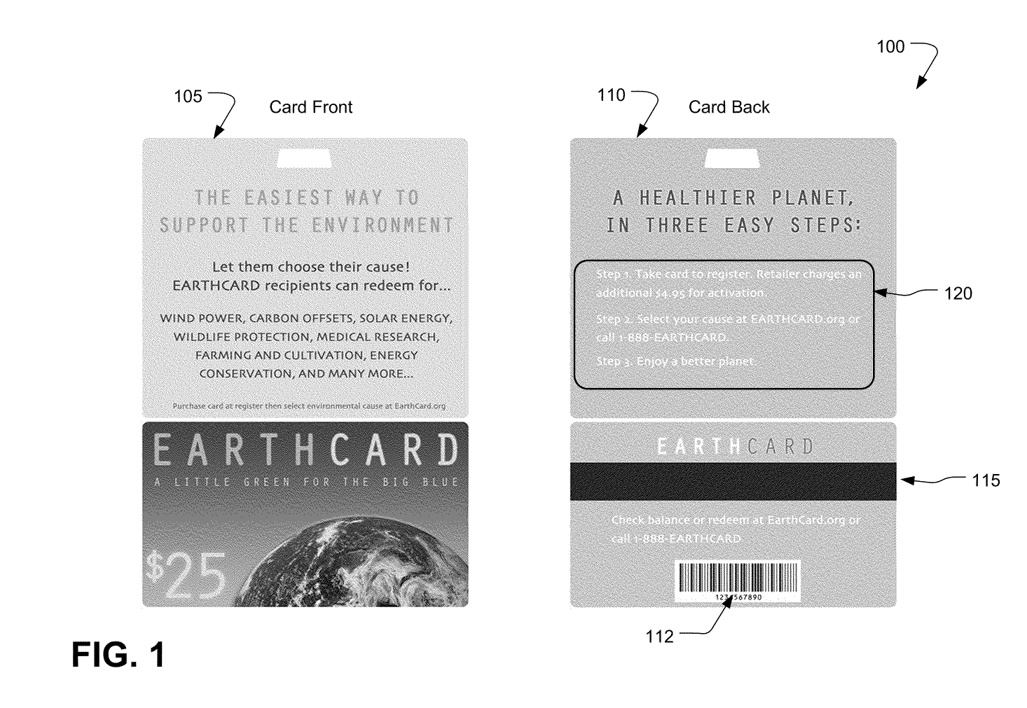

FIG. 1 illustrates a design layout for an exemplary cause gift card 100. The cause gift card 100 may be branded for a specific cause, which could include, but is not limited to Earth Gift Cards (for environmental causes), Health and Wellness Cards (for disease research), Political Action Cards (for donations to campaigns, parties, or candidates), Animal Rescue Cards, Campaign for Children's Health, and others.

Generally, a cause gift card 100 may be sold online or in retail locations, and may be in the format of a physical gift card or an electronic gift card. Either format may enable funds associated with the cause gift card ID to be transferred to, for example, non-profit institution(s), to a for-profit company(ies) that provides services that are deemed beneficial in the context of a specific cause being marketed using the cause gift card, and others.

In one implementation, a cause gift card 100 has a front side 105 and a back side 110. As depicted in FIG. 1, the back side 110 of the cause gift card 100 contains a barcode 112 and/or encoded magnetic stripe 115 that contains data indicating the unique cause gift card ID. In one implementation, the cause card 100 may include a product ID or SKU that is specific to the merchant selling the card, and may be rendered in a barcode font, such as Code 128, European Article Numbering (EAN), Code 3 of 9, or other applicable specification, in a manner such that the merchant point of sale (POS) system can recognize the cause card ID. In one implementation, the card may include instructions 120 on how to redeem the value. Generally, the instructions 120 may be directed to using a website using an interactive voice response (IVR) system number, and others.

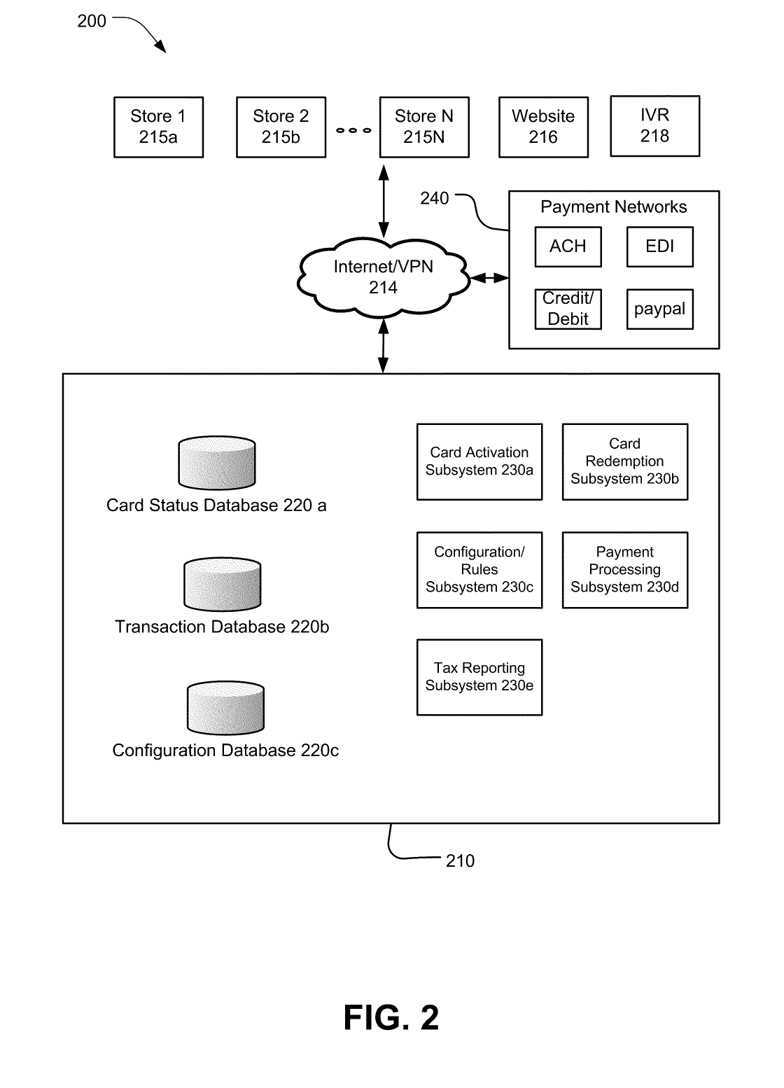

FIG. 2 illustrates an exemplary cause gift card environment 200 for processing merchant activity via a networked card processing system, e.g. a server computer with Internet connections to merchant systems 215a-N. As shown in FIG. 2, the card processing system 210 may include several subsystems, for example, a card activation subsystem 230a, a card redemption subsystem 230b, a configuration/rules subsystem 230c, a payment processing subsystem 230d, and a tax reporting subsystem 230e. The subsystems of the card processing system 210 may include various rules and/or logic to determine, for example, information associated with a particular cause gift card. For example, the card activation subsystem 230a may determine whether a cause gift card has been activated and provide access to additional subsystems. The functionality of the subsystems of the card processing system 210 will be discussed in further detail below.

In one implementation, the card processing system 210 may enable the recipient of a cause gift card to select from a pre-defined basket of options specific to a cause gift card ID. By selecting one of the pre-defined basket of options the recipient may redeem funds for that card. These options may include funding or receipt of specific items and/or services provided by or available from a single organization 215a or across multiple organizations 215a, 215b . . . 215N, where N may be any number and may indicate the total number of organizations. The cause gift card may differ from traditional gift cards that allow the recipient to redeem the card value at only one organization, which is generally the same as the card issuer, and may also differ from generic charity gift cards that enable the user to select from a large basket of not-for-profit companies only.

In one implementation, the card processing system 210 may include a client/server processing system that may interact with multiple merchant systems, which may be physical store locations 215a, 215b . . . 215N, websites 216, or IVR systems 218. The client/server processing system 210 may also allow multiple merchant systems to connect via a communications network 214 such as the Internet, using a virtual private network (VPN), or other type of connection method. Additionally, the card processing system 210 may accept transactions from multiple merchant POS systems and websites which may include formats such as International Organization for Standardization (ISO) messages, extensible markup language (XML), simple object access protocol (“SOAP), hypertext transfer protocol (HTTP) post, and other standards suggested by participating merchants and websites. Transactions may be initially processed between the merchant POS 215a-N and the card processing system 210 using a payment network 240, for example, the Automated Clearing House (ACH), Electronic Data Interchange (EDI), a Credit/Debit network, or the PayPal™ system.

Furthermore, the card processing system 210 may contain multiple databases 220a-c for storing card parameters, including activation and redemption details. In FIG. 2, the card processing system 210 includes a card status database 220a, transaction database 220b, and configuration database 220c. The card status database 220a may store information regarding whether the cause gift card is activated and redemption time period for the cause gift card once the card has been activated. The transaction database 220b may store the transaction history of the cause gift cards. The configuration database 220c may store information for configuring different types of cause gift cards, for example, a specific merchant association or a listing of associated recipient or redemption entities.

In one implementation, the card processing system 210 may also include a business rules engine 230c that includes logic for managing automated redemption and redemption rules and methods as determined by card type, seller of the card, and other parameters as deemed necessary. For example, a card sold by Merchant A may be defined with an auto-redemption period of six months. This may mean that if a consumer action is not taken to manually redeem any or all of the funds on the cause gift card within the six-month period after purchase and activation, then any funds remaining on the card at the date that is six months from when the card was activated would be automatically redeemed. In addition to varying the auto-redemption time period, the redemption rules could also vary. For example, for Merchant A if funds are auto-redeemed, 100% of the funds on the card may be sent to Organization 1. However, different automatic redemption rules may be applied for Merchant B and the funds on a card purchased from Merchant B may be distributed as follows: 33% to Organization 1, 33% to Organization 2, and 33% to Organization 3. Any of a variety of other redemption rules related to expiration dates, recipient organizations, card type, card seller, purchase date, geographic location, and others can be implemented by the business rules engine 230c to determine how funds on a particular card are redeemed and distributed.

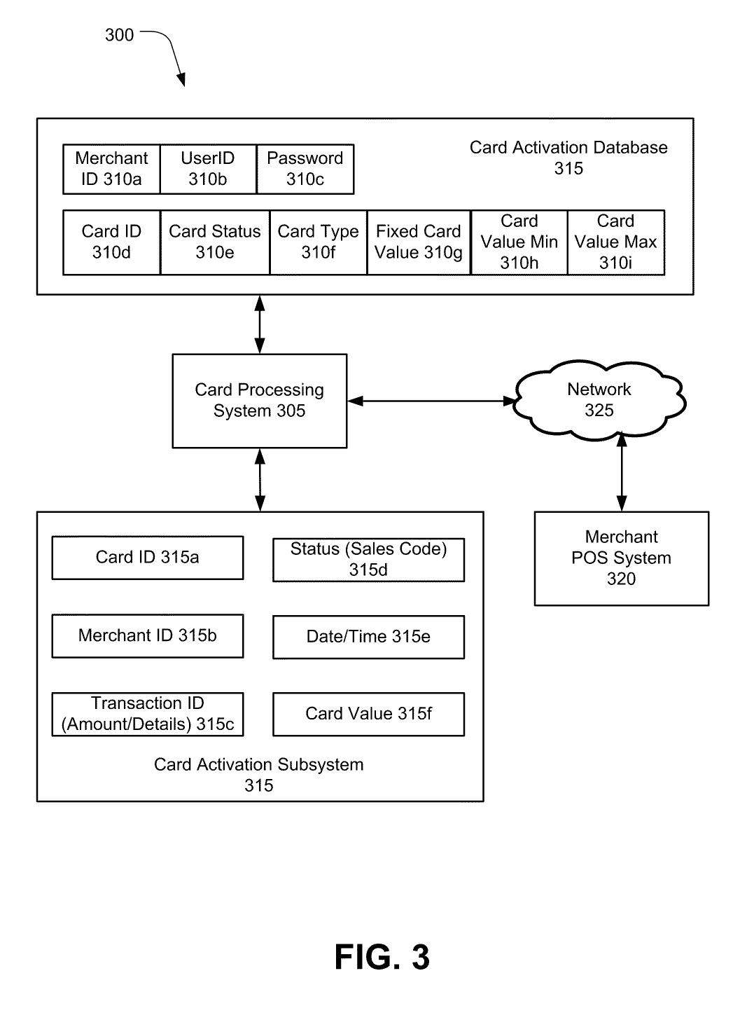

FIG. 3 illustrates an exemplary architecture 300 for activation of a gift card in a cause card environment. In one implementation, as part of the card processing system 305, the card activation system 310 may contain logic that interfaces with the card activation database 315 to determine the status of the card and may return information to a merchant POS system 320 during the activation process. For example, elements of the card activation database 315 may include a merchant ID 310a and access information for that merchant, for example, a user ID 310b and password 310c. The database 315 may also be populated with information specific to each issued cause gift card, for example, a card ID 310d, a card status 310e, a card type 310f, a fixed card value 310g, a minimum card value 310H, a maximum card value 310i, and any other desirable data for association with a cause gift card.

In one implementation, the logic in the card activation system 310 may accept an incoming card ID 315a and merchant ID 315b from the merchant POS system 320 via the network 325, determine the status of the card, and may respond to the merchant POS system 320 with a sales code 315d indicating whether the card is in a state where it can be activated successfully. The merchant POS system 320 may use this information to process the transaction, and may send a response through the card processing system 305 indicating whether the cause gift card ID 315a was activated, and if so, may include the activation value 315f. This information may be updated in the card activation database 315. Upon the completion of a successful transaction at the point of sale, the merchant POS system 320 may send a record of the successful transaction, including card ID 315a, a store or merchant ID 315b, a transaction record 315c (e.g., including and ID, a transaction amount, and purchase details), date and timestamp 315d, the remaining value on the card 315f, and other information as deemed necessary to the card processing system 305.

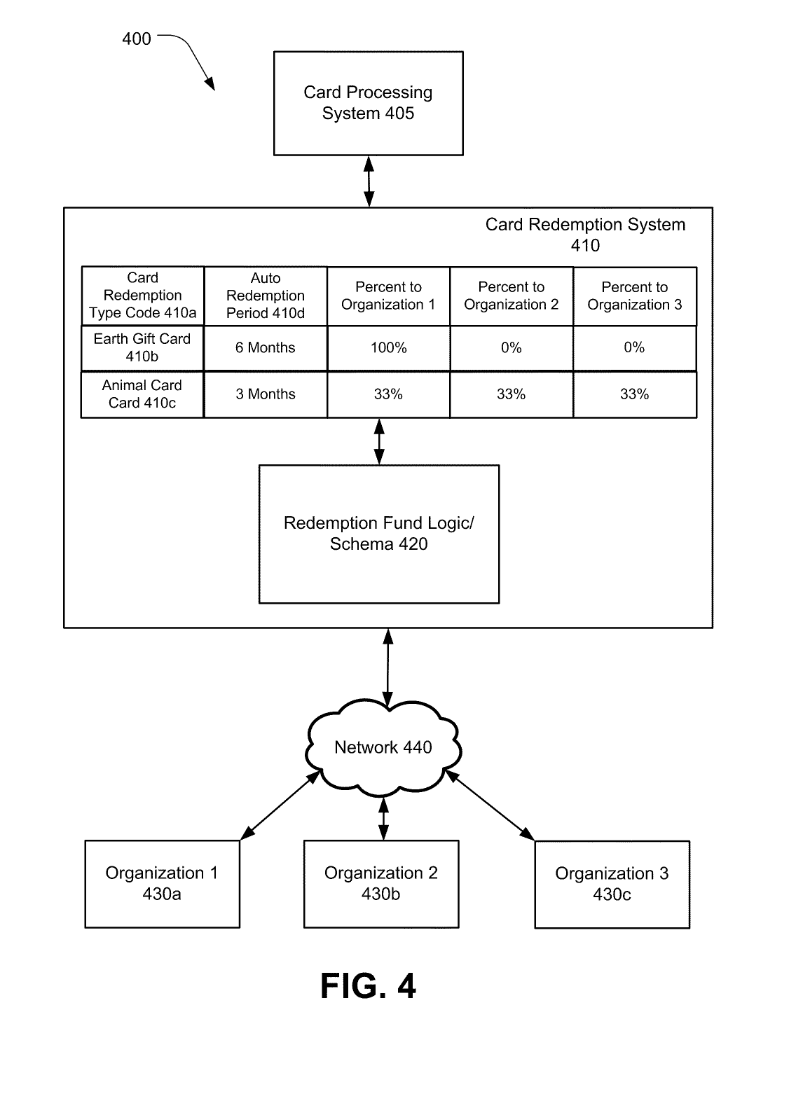

FIG. 4 illustrates an exemplary architecture for redemption of a cause gift card in a cause gift card environment 400. In one implementation, the card processing system 405 may include a card redemption system 410 (corresponding to the card redemption subsystem 230b in FIG. 2) that may manage the manual and automated disbursement of cause gift card funds to participating entities. The card redemption system 410 may receive manual (customer initiated) redemption requests from multiple means, including a website, a mobile device, or an IVR. Furthermore, the manual redemption request may include the cause card ID and the card redemption system 410 can check the status of the cause card with the card processing system 405 to determine if it is in a state that permits redemption. If the cause gift card is not in a state that permits redemption, then an error message may be returned to the customer. By contrast, if the cause gift card is in a state that enables redemption, then the card redemption system 410 may return a menu of redemption options to the customer through the website, mobile device, IVR, or other means. In one example, the manual redemption request may also include a special code such as a security code or activation code.

When a redemption process is initiated, either manually or according to auto-redemption rules, the card redemption system 410 may create a fund distribution file that aggregates payment amounts for each participating recipient organization based on amounts that have been selected and authorized for redemption for each card ID. These fund allocations may be made manually by the card recipient, e.g., by visiting a website interface with the card redemption system that presents the options for funds distribution indicated available by the business rules engine 230c for the particular card type. This fund distribution file is subsequently used by the payment processing sub-system 230d to initiate the movement of funds to participating organizations either selected manually by the card recipient or automatically through the auto-redemption rules.

The card processing system 405 may be similar to the card processing system 210 and may include similar elements such as the databases and subsystems discussed with respect to FIG. 2. As previously discussed, the card redemption system 410 may access information from the card processing system 405 regarding the redemption status of the cause gift card. In doing so, the card processing system 405 may provide information such as, the activation status of the cause gift card, payments or donations that have been previously deducted from the balance of the cause gift card, and the balance of funds remaining on the cause card. This information may be provided by other subsystems, for example, the card activation system 230a, the payment processing subsystem 230d, and other subsystems as discussed with respect to FIG. 2.

In another implementation, the basket of redemption options may differ for each cause gift card ID, and may be determined based on several parameters. One such parameter may be, for example, the type of cause gift card e.g., an Earth Gift Card, an Animal Care Card, and others. Another parameter may be the seller of the card as the redemption options may differ per retailer. For example, the redemption options may differ for an Earth Gift Card sold by Best Buy™ as opposed to Wal-Mart™ depending upon recipient allocations selected by retailer.

In another implementation, the menu of available redemption options may depend on the cause gift card ID. The menu may enable the customer to select one or multiple redemption options as part of the redemption transaction. As such, based on the customer's selection, the system may identify the cause gift card redemption type, and the company/companies eligible for redemption, and will validate the amount available for redemption which may be the remaining balance on the card. The system may then initiate redemption to the selected companies either in real-time or by matching up amounts across cause gift cards and then transferring the data to the companies at periodic intervals. The manner of data transfer may be specific to each company and may be determined by the redemption/funding logic for each company. Methods for transferring redeemed funds may include, for example, but are not be limited to ACH transfer of funds, direct deposit of funds to participating entity's bank account, transfer of value using credit or debit networks, such as Visa™ or American Express™, or EDI transfer of funds.

A client server system may include a business rules engine that may automatically send funds to a company/entity if the cause gift card value is not redeemed by the recipient within a certain period of time. The rule(s) on the period of time may be set by card type, by participating merchant or seller or by other parameters, and the disbursement rules may enable a percent of the funds to be distributed to one or many of the participating entities on the card. Furthermore, a redemption system may include redemption fund logic schema 420 that includes software code and database logic. The logic included in the redemption fund logic schema 420 may permit the cause gift card value to be distributed among multiple, unrelated or related entities 430a, 430b, 430c, which may include both for-profit and not for-profit entities via a network 440, such as the Internet or a VPN. The allocation logic may be applied to the total redemption value, and could enable the recipient of the cause gift card to select the percent of total amount or some portion of the value that may be allocated to each participating company/entity.

In another implementation, the card processing system 405 may contain business rules and system code for enabling the automatic redemption of funds in the event the recipient of the cause gift card does not redeem the full value on the card within a set period of time. The logic flow for the automatic redemption subsystem may distribute and verify that the value distributed is allocated to companies that are part of the card redemption options and in a manner that is defined by pre-set business rules. One such definition for distribution may allocate, for example, 50% to organization A and 50% to organization B. The period after which the automated redemption logic may apply may be determined by several variables, including, but not limited to, card type, and merchant or seller of the cause gift card.

In the example of FIG. 4, the card redemption type code 410a may be the type of cause gift card type of Earth Gift Card 410b or an Animal Care Card 410c. An automatic redemption period 410d may be associated with each type of cause gift card. As shown in FIG. 4, the Earth Gift Card 410b may be associated with six months and the Animal Care Card 410C may be associated with three months. An automatic percentage allocation of the total value of the card between entities may vary depending on the cause gift card type. In FIG. 4, for example, if the cause gift card is an Earth Gift Card 410b, then 100% of the value of the cause gift card may be allocated to Organization 1. Alternatively, if the cause gift card is an Animal Care Card 410c, then 33% of the value of the cause gift card may be allocated between three companies, Organization 1, Organization 2, and Organization 3.

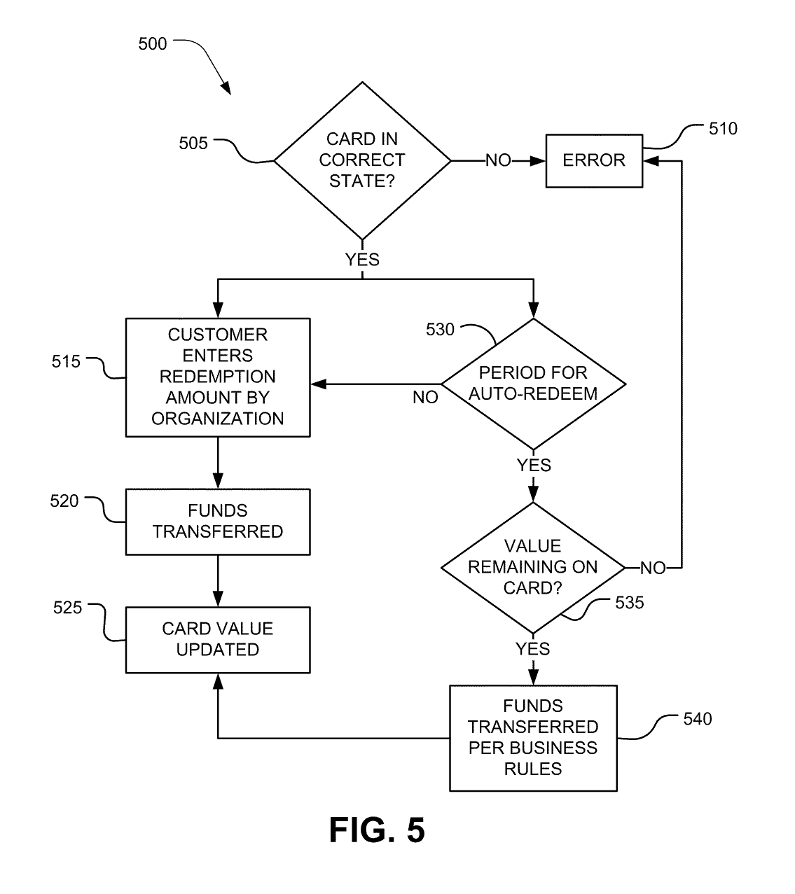

FIG. 5 illustrates exemplary operations for redeeming a gift card in a cause gift card environment. At operation 505, the state of the cause gift card may be determined. If the cause gift card may be determined as not within a correct state (e.g., it is not activated or value has already been depleted), then an error message may be returned at operation 510. Alternatively, if at operation 505, the card is in a correct state, then at operation 515 a customer may be prompted to enter a redemption amount or amounts by company, organization, or entity,. At operation 520, funds may be transferred to the appropriate participating organization and at operation 525 the cause gift card value may be updated to reflect the remaining value.

Additionally, at operation 530 it may be determined whether a period for manual redemption has elapsed. If at operation 530 the period for manual redemption has elapsed, then at operation 535 the remaining value on the cause gift card may be determined. Alternatively, if the manual redemption period has not elapsed, the user may still enter a redemption amount as indicated in operation 515. If at operation 535 there is value remaining on the card, then at operation 540 funds may be transferred with reference to predetermined rules (e.g., business rules). In the event the cause gift card does not have any remaining value, then an error may be indicated as shown in operation 510.

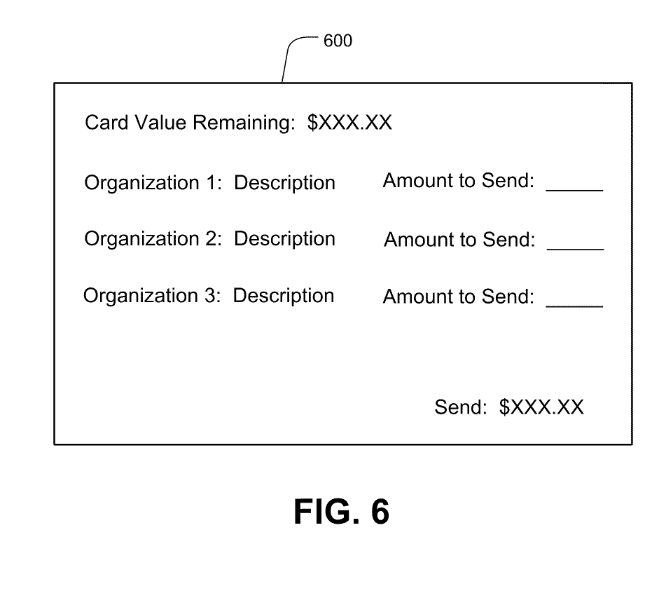

FIG. 6 illustrates an example screen shot 600 for redeeming a gift card in a cause card environment. In FIG. 6, an exemplary implementation may allow the ability to access redemption through a website, IVR, Web-enabled mobile device, or other means as deemed necessary, and may provide information including, but not limited to, the card value remaining, descriptions of possible orgainizations, companies or other entities, amount to apply to different organizations, companies or entities, etc. In order to access this information, the customer may be asked to provide information including the cause card ID and the cause card PIN if such information is required and present on the cause gift card.

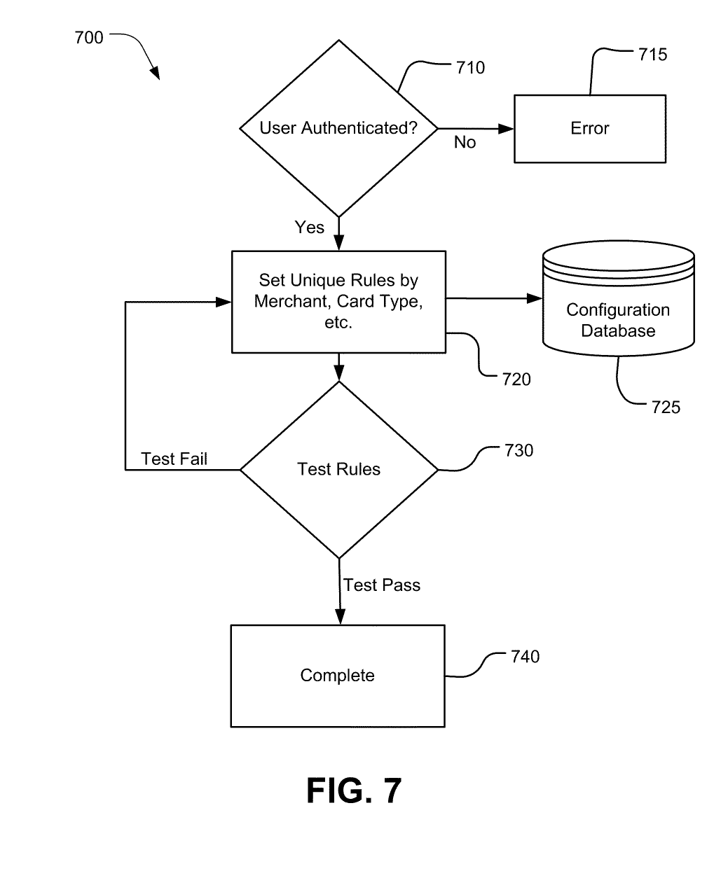

As shown in FIG. 7, a configuration rules subsystem may authenticate an authorized system administrator. The authorized system administrator is then enabled to access the system via a web enabled device, including but not limited to, a personal computer, a portable computing system, a mobile device, a personal digital assistant, or a telecommunications device. If the system administrator is not authenticated, then the configuration rules subsystem may provide an error as shown in operation 715.

In operation 720, the system administrator may establish rules for redemption, which can include, but are not limited to, establishing the basket of qualifying organizations or companies for redemption by merchant. For example, one Earth Gift Card implementation may be in conjunction with Target™, stores which may have a pre-existing relationship with for-profit and/or not-for-profit institutions which they would like available in the redemption options. Alternatively, Best Buy may not have a relationship with the same for-profit and/or not-for-profit institution, and may request that a different selection be made available as a redemption offer for cards sold at its retail establishments. These rules may be established by indicating and/or accessing relationships in a database (as shown in operation 725), in software code and/or other systems. In operation 730, the rules may be rendered during applicable transactions that occur within the card processing system, including both real-time and batch transactions. As shown in operation 730, the rules may pass and the system administrator may proceed to completion in operation 740. Alternatively, the rules may not pass and the system administrator may proceed to operation 720 to attempt to process the cause card via the rules again.

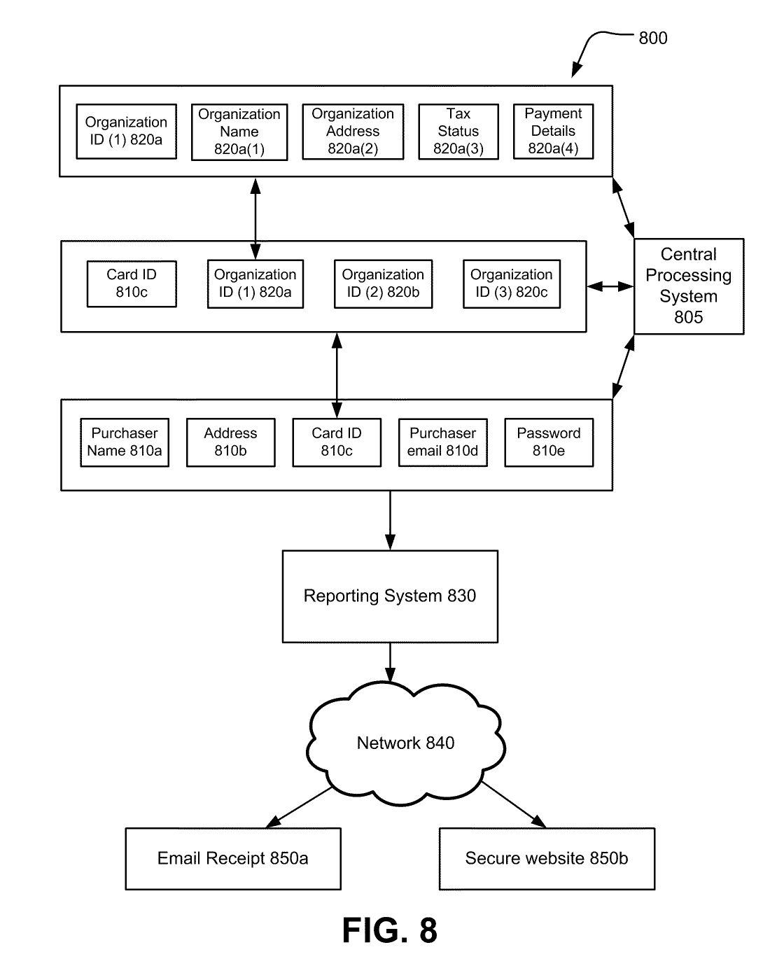

In one implementation as shown in FIG. 8, a tax reporting subsystem 800 may enable the purchaser of the cause gift card to access the tax reporting subsystem 800 via a website 850b over a network 840, IVR, or other interface as appropriate and the purchaser may provide information to register the cause gift card. The information may include a purchaser name 810a, a purchaser address 810b, purchased cause card ID(s) 810c, a purchaser email address 810d, a password 810e, and/or other information, or any combination thereof. However, depending upon the particular provisions of tax codes in effect, the recipient of the cause gift card may be able to take advantage of the tax exemption rather than the purchaser. The tax reporting subsystem 800 may additionally query the registrant of the cause gift card to determine whether the registrant is the purchaser or recipient of the card and apply appropriate business rules related to the relevant tax code to determine whether the registrant is able to take advantage of any tax exempt donations that may occur upon redemption of the cause gift card.

Upon redemption of the cause cards, the tax reporting subsystem 800 may validate the tax-exempt status of the organizations identified by organization IDs 820a, 820b, 820c that the funds were disbursed to for a particular card ID 810c. Information regarding each of the organizations may be stored in a related table with data field that may include the respective organization ID 820a, organization name 820a(1), organization address 820a(2), tax status 820a(3), and payment details 820a(4) (e.g., the desired method of or account information for transferring funds to the organization), may also be included in the tax reporting subsystem 800.

The tax reporting subsystem 800 may generate a tax report based on the information provided by the purchaser and on the tax-exempt status of the organization(s) to which the cause gift card funds were disbursed. The tax report may be sent to the purchaser so that the purchaser may know whether the cause gift card value, or a portion thereof, is tax deductible or not. For example, if the receiver of the gift cause card opts to disburse the value of the gift cause card to a tax-exempt organization, the purchaser of the gift cause card may receive a tax report indicating this and the value of the gift cause card may be tax deductible. These processing operations would not vary based on the tax status of the organization funds are sent to. However, if the recipient or one or more of multiple recipients of a disbursement related to a particular cause gift card is a not a tax exempt organization, the tax report generated by the reporting system 830 will reflect that none or only a portion (as the case may be) of the funds placed on the gift card are eligible for a tax reduction. In these examples, the purchaser is viewed as the entity eligible to receive any available tax deduction.

For the organizations and/or companies that are eligible for tax-exempt status, the system 800 may generate a report using reporting system 830. The report may be sent to the purchaser via e-mail 850a using a network 840 such as the Internet or VPN, or made accessible through secure access from a website 850b, or by other appropriate means. The report may contain information necessary to claim the entirety or a portion of the purchase cost of the cause gift card as a charitable donation for tax reporting purposes. In another implementation, the tax reporting subsystem may provide reports to an authorized system administrator and may indicate all of the funds that have been redeemed at eligible charitable institutions for which there is no registered purchaser. If there is no registered purchaser of a particular cause gift card presented for redemption, it may be unclear whether and/or who would be able to claim the tax benefit for funds sent to eligible tax exempt companies. As such, the tax reporting subsystem may aggregate this redemption data and make it available to a system administrator for use in analysis of a potential beneficiary. For example, the entity that processes the cause gift cards may be able to claim the tax benefit in select cases.

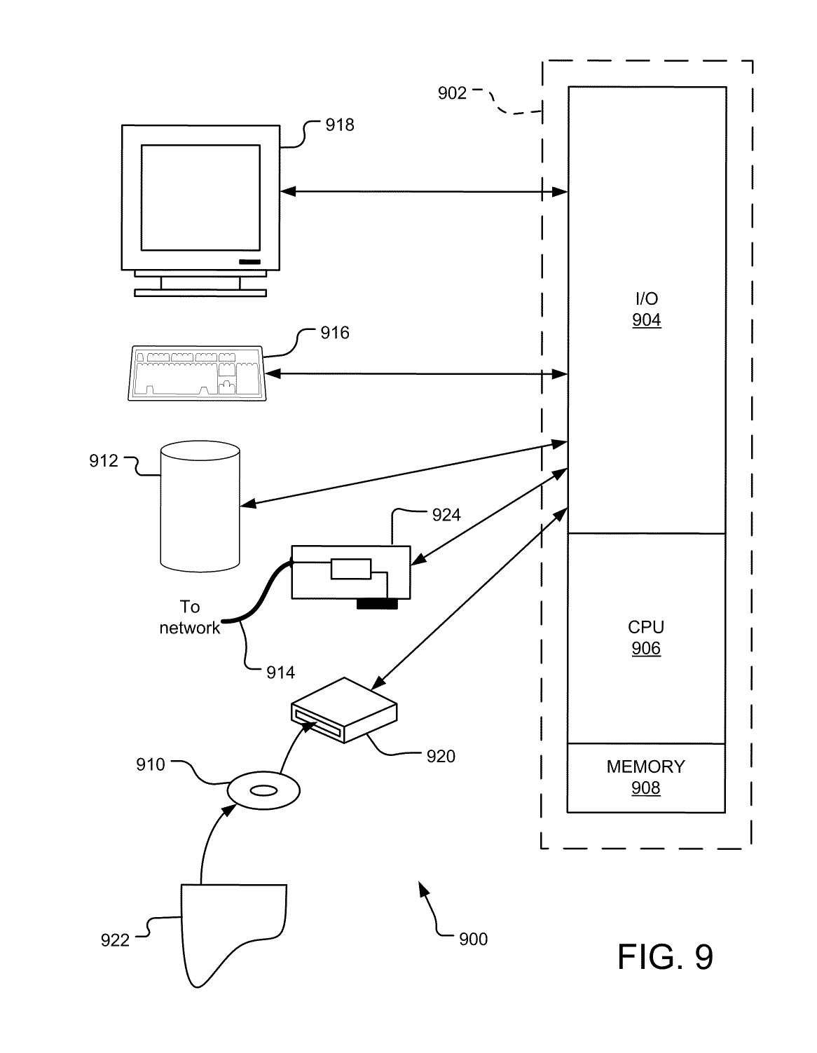

FIG. 9 illustrates an example system for implementing the described technology. In FIG. 9, a general purpose computer system 900 may be capable of executing a computer program product that executes a computer process. Data and program files may be input to the computer system 900, which reads the files and executes the programs therein. Some of the elements of a general purpose computer system 900 are shown in FIG. 9 wherein a processor 902 is shown having an input/output (I/O) section 904, a central processing unit (CPU) 906, and a memory section 908. There may be one or more processors 902, such that the processor 902 of the computer system 900 comprises a single central-processing unit 906, or a plurality of processing units, commonly referred to as a parallel processing environment.

The computer system 900 may be a conventional computer, a distributed computer, or any other type of computer. The described technology may be optionally implemented in software devices loaded in memory 908, stored on a configured DVD/CD-ROM 910 or storage unit 912, and/or communicated via a wired or wireless network link 914 on a carrier signal, thereby transforming the computer system 900 in FIG. 9 to a special purpose machine for implementing the described operations.

The I/O section 904 may be connected to one or more user-interface devices (e.g., a keyboard 916 and a display unit 918), a disk storage unit 912, and a disk drive unit 920. Generally, in contemporary systems, the disk drive unit 920 is a DVD/CD-ROM drive unit capable of reading the DVD/CD-ROM medium 910, which typically contains programs and data 922. Computer program products containing mechanisms to effectuate the systems and methods in accordance with the described technology may reside in the memory section 904, on a disk storage unit 912, or on the DVD/CD-ROM medium 910 of such a system 900. Alternatively, a disk drive unit 920 may be replaced or supplemented by a floppy drive unit, a tape drive unit, or other storage medium drive unit. The network adapter 924 may be capable of connecting the computer system to a network via the network link 914, through which the computer system can receive instructions and data. Examples of such systems include SPARC™ systems offered by Sun Microsystems, Inc., personal computers offered by Dell Corporation and by other manufacturers of Intel-compatible personal computers, PowerPC-based computing systems, ARM-based computing systems and other systems running a UNIX-based or other operating system. It should be understood that computing systems may also embody devices such as personal digital assistants, mobile phones, gaming consoles, set top boxes, and so on.

When used in a LAN-networking environment, the computer system 900 may be connected (by wired connection or wirelessly) to a local network through the network interface or adapter 924, which may be one type of communications device. When used in a WAN-networking environment, the computer system 900 typically may include a modem, a network adapter, or any other type of communications device for establishing communications over the wide area network. In a networked environment, program modules depicted relative to the computer system 900 or portions thereof, may be stored in a remote memory storage device. It is appreciated that the network connections shown are exemplary and other means of and communications devices for establishing a communications link between the computers may be used.

In an exemplary implementation, card activation systems, card redemption systems, and other modules may be incorporated as part of the operating system, application programs, or other program modules. Orders logs, products databases, user databases, order code databases, transaction logs, and other data may be stored as program data.

The technology described herein is implemented as logical operations and/or modules in one or more systems. The logical operations may be implemented as a sequence of processor implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language.

The above specification, examples and data provide a complete description of the structure and use of example embodiments of the invention. Although various embodiments of the invention have been described above with a certain degree of particularity, or with reference to one or more individual embodiments, those skilled in the art could make numerous alterations to the disclosed embodiments without departing from the spirit or scope of this invention. In particular, it should be understood that the described technology may be employed independent of a personal computer. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

Although the subject matter has been described in language specific to structural features and/or methodological arts, it is to be understood that the subject matter defined in the appended claims is not necessarily limited to the specific features or acts described above. Rather, the specific features and acts described above are disclosed as example forms of implementing the claimed subject matter.

These and other example embodiments are described and shown in the one or more attached Appendices, filed concurrently herewith and incorporated herein by reference for all purposes.

What is claimed is:

1. A method in a computer system for redemption of cause gift cards comprising generating a roster of unaffiliated entities for receipt of a value associated with a cause gift card;
providing instructions for redeeming the cause gift card, the instructions including an allocation of benefits, represented by the cause gift card, between one or more of the unaffiliated entities; and
distributing the benefits to one or more accounts of the respective one or more unaffiliated entities according to the allocation.

2. The method of claim 1 further comprising transferring a card identification associated with the cause gift card to a merchant system.

3. The method of claim 2 further comprising transferring the card identification to a card processing system.

4. The method of claim 1 further comprising identifying a redemption period provided by the cause gift card.

5. The method of claim 4 further comprising enabling the redemption period to vary based on at least one of a merchant selling the card or a card type.

6. The method of claim 4 further comprising automatically performing the distributing operation to one or more of the unaffiliated entities on the roster upon expiration of the redemption period according to the instructions.

7. The method of claim 1 further comprising defining a card type for the cause gift card.

8. The method of claim 1 further comprising enabling a system administrator to define a list including at least two of the one or more unaffiliated entities eligible for redemption of funds for each cause type, wherein the unaffiliated entities include both for-profit and not-for-profit entities.

9. The method of claim 1 further comprising varying redemption options available for a specific card identification based on business rules that enable redemption options to be dynamically presented to a consumer.

10. The method of claim 1 further comprising receiving registration information from a purchaser of the cause gift card.

11. The method of claim 10 further comprising tracking a tax status of the unaffiliated entities to which funds are distributed for the cause gift card.

12. The method of claim 11 further comprising reporting to the purchaser of the cause gift card an amount of funds eligible for charitable deduction.

13. A computer-readable storage medium, the computer readable storage medium storing a computer-executable code that, when executed by a computing system, causes the computing system to perform operations comprising
generating a roster of unaffiliated entities for receipt of a value associated with a cause gift card;
providing instructions for redeeming the cause gift card, the instructions including an allocation of benefits, represented by the cause gift card, between one or more of the unaffiliated entities; and
distributing the benefits to one or more accounts of the respective one or more unaffiliated entities according to the allocation.

14. The computer-readable storage medium of claim 13 wherein the operations further comprise identifying a redemption period provided by the cause gift card.

15. The computer-readable storage medium of claim 14 wherein the operations further comprise enabling the redemption period to vary based on at least one of a merchant selling the card and a cause gift card type.

16. The computer-readable storage medium of claim 15 wherein the operations further comprise automatically performing the distributing operation to each of the unaffiliated entities on the roster when the redemption period terminates.

17. A method for redeeming cause gift cards executing on a card processing system with a computer-readable storage medium, the computer readable storage medium storing a computer-executable code that, when executed by the card processing system, configures the card processing system to perform operations comprising
enabling a plurality of merchant systems to connect to the card processing system;
accepting transactions for the purchase of cause gift cards at the card processing system from multiple merchant systems;
storing cause gift card parameters on at least one database included within the card processing system;
employing a business rules engine included within the card processing system to manage automated redemption and redemption rules based on a type of cause gift card; and
distributing funds associated with respective cause gift cards to one or more unaffiliated entities.

18. The method of claim 17 further comprising enabling a recipient of a cause gift card to select a redemption option from a pre-defined set of redemption options.

19. The method of claim 18 wherein the pre-defined set of redemption options comprises one or more items or services available from the one or more unaffiliated entities.

20. The method of claim 17 further comprising identifying a redemption period provided by a particular cause gift card.

21. The method of claim 20 further comprising determining a state of the particular cause gift card by verifying available funds associated with the particular cause gift card and verifying that the redemption period has not terminated.

22. The method of claim 20 further comprising enabling the redemption period to vary based on at least one of a merchant selling the particular cause gift card and the type of cause gift card.

23. The method of claim 20 further comprising automatically performing the distributing operation to one or more of the unaffiliated entities when the expiration period terminates.

24. A method for redeeming cause gift cards executing on a card processing system with a computer-readable storage medium, the computer readable storage medium storing a computer-executable code that, when executed by the card processing system, configures the card processing system to perform operations comprising
receiving registration information from a purchaser after the purchaser user purchases a cause gift card;
tracking a redemption status of the cause gift card;
generating a tax report based on the redemption status of the cause gift card; and
sending the tax report to the purchaser once the cause gift card is redeemed.

25. The method of claim 24 further comprising receiving redemption information regarding the cause gift card including identification of one or more unaffiliated entities receiving a disbursement of funds corresponding to the cause gift card.

26. The method of claim 25 further comprising classifying a tax status of the one or more unaffiliated entities.
